(19) United States
(12) Patent Application Publication
(10) Pub. No.: US 2007/0080484 A1
(43) Pub. Date: Apr. 12, 2007

(54) Method of producing a pitch binder for an electrode material

(76) Inventors: Vladmir K. Frizorger, Krasnoyarsk (RU); Victor C. Mann, Krasnoyarsk (RU); Alexander N. Anushenkov, Krasnoyarsk (RU); Sergey A. Khramenko, Krasnoyarsk (RU)

Correspondence Address: SILBER & FRIDMAN, 1037 ROUTE 46 EAST, SUITE 207, CLIFTON, NJ, 07013, US

(21) Appl. No.: 11/545,169

(22) Filed: Oct. 10, 2006

(30) Foreign Application Priority Data
Oct. 10, 2005 (RU) RU 2005131099

(51) Int. Cl. B06B 1/02

(52) U.S. Cl. 264/442

(57) ABSTRACT

A method of producing binding pitch for an electrode material comprises the steps of enriching and exposing. The liquefied coal pitch-based component is initially enriched with air, and then is exposed to a field of hydropercussion and cavitation pulses. In this manner, a process of oxidation of the coal pitch-based component is accelerated.

### FIELD OF THE INVENTION

The invention relates in general to the field of metallurgy, more specifically it relates to preparation of coal pitch utilized in the production of anode pastes, coal and graphitized products, and structural carbon-graphite materials.

### BACKGROUND OF THE INVENTION

The commercial carbonization of coal produces gas, coke, and tar. Coal tar is a primary by-product material produced during the destructive distillation or carbonization of coal into coke. While the coke product is utilized as a fuel and reagent source in the metallurgical industry, the coal tar material is distilled into a series of fractions. A significant portion of the distilled coal tar material is the pitch residue. This material is utilized in the production of anodes for aluminum smelting, for electric arc furnaces used in the steel industry, and other applications. One of the well known applications of the coal tar pitch is as a binder for carbon electrodes used in the electrolytic production of aluminum and adapted to carry substantial electric currents. Pitch employed in such a way is known as electrode pitch. The desirable characteristics of these carbon electrodes are high density, high modulus of elasticity, high electrical conductivity, etc.

In the production of electrodes porous and channeled structures are formed resulting in a reduced density and reduced capacity of the carbon element for carrying current. Impregnating pitches are used to fill the pores and channels to increase the carbon density and thus improve the current carrying capacities of the electrodes.

In evaluating the qualitative characteristics of the pitch material, the prior art has been primarily focused on the ability of the coal tar pitch material to provide a suitable binder used in the anode and electrode production processes. Various characteristics, such as softening point, specific gravity, percentage of volatiles insoluble in quinoline (the α-fraction), percentage of material insoluble in toluene (the α₁-fraction), and the coking value have all served to characterize coal tar pitches for applicability in these various manufacturing processes and industries. Softening point is the basic measurement utilized to determine the distillation process end point in coal tar pitch production and to establish the mixing, forming or impregnating temperatures in carbon product production.

A method of electrode pitch production by means of flash evaporation of coal tar heated in a pipe heater to the temperature between 390 and 410° C. is known in the art. However, this method does not substantially affect the quality or characteristics of the pitch such as the content of α- and α₁-fractions, etc, which are strongly dependent on coal tar characteristics.

To solve this problem, additional treatments to the pitch or blends of coal tar oils or pitch distillates are often utilized. These treatments increase the softening temperature, increase α-fraction content and decrease the volatilization.

One such method of treating pitch is disclosed by USSR Inventor's Certificate No. 166,300 (1964). This document discloses the medium pitch which is diluted with an anthracene fraction. The resulting mixture is then thermally treated for 5 to 7 hours at the temperature between 360 and 380° C., while continuously running through a pipe heater. This method increases the content of α-fraction in the pitch up to 30-35%, the α₁-fraction up to 15%, at a softening temperature between 80 and 104° C.

Another method of modifying the characteristics of the pitch is disclosed in Great Britain Patent No. 1,249,569 to Holdsworth. According to this method, the medium pitch is added to the coal tar fraction having a boiling range between 210° C. and 320° C. in the ratio between 9:1 and 1:1. The mixture is treated at the temperature range between 370° C. and 390° C. for a period of 6 to 8 hours. As a result, the pitch having a softening point of 60° C., α-fraction content of 21% and α₁-fraction content of 6% is being converted into the pitch having the boiling point between 93° C. and 104° C. and having the α-fraction 30% and 36% as well as α₁-fraction content of 15%.

The primary drawback of these prior art methods is that they are inefficient. The processes must run for many hours, as the rate of thermal transformation in the pitch is slow. Further, the thermal treatment process in many prior art methods must be carried out under pressure to maintain the boiling temperature of the tar fraction to be lower than the thermal treatment temperature. Thus, complex and expensive equipment must be utilized to satisfy these conditions.

Russian Patent No. 2,241,016 describes another method in which the coal tar pitch or its mixture with fractions of coal tar distillates or its mixture with pitch distillates is treated with air. This is done at a temperature range between 350 and 380° C. with an air flow rate of less than 10 m³/hour. After this, the pitch is exposed to the thermal treatment at temperatures between 350° C. and 380° C. for 5 to 12 hours.

The drawback of this method is that the duration of thermal exposure is long (5-12 hours) and the initial material must be treated by air at high temperatures of 350° C. and higher. At such temperatures, during oxidation of coal tar pitch in the steam medium (vapor phase) the carbohydrates with high molecular weight are present. Polycondensation of such carbohydrates causes formation of large oligomers with biphenylic cross bonds. The mobility of such oligomers decreases as temperature and time of the oxidation process increases. Predominance of these carbohydrates increases viscosity of the pitch under conditions of self-baking anodes and negatively affects its properties. By way of comparison, low-temperature (below 300° C.) oxidation and synthesis involves relatively smaller oligomers and has little effect on the viscosity and behavior of pitches in the self-baking anode environment.

Thus, it has been a long-felt and unsolved need to provide a method of modifying the characteristics of tar pitch, such as the softening point, α-fraction content, and of α₁ content, with increased speed and productive capacity. There has been a further need to carry out this process at low temperatures so that the chemical composition of the carbohydrate chains of the pitch is not modified.

### SUMMARY OF THE INVENTION

A method of producing binding pitch for electrode materials is provided consisting of the steps of enriching and exposing. Initially a liquefied coal pitch-based component is enriched with air. Then, this enriched component is exposed to a field of hydropercussion and cavitation pulses. The method also includes a step of heating, wherein the coal pitch-based components is heated to a temperature not exceeding 240° C. for a time period not exceeding one hour.

According to another aspect of the invention, the enriched coal pitch-based component is exposed to the hydrodynamic and cavitation pulses having frequency not exceeding 4500 pulses per second. The hydrodynamic and cavitation pulses are provided to accelerate the process of oxygenation of the coal pitch-based component by air.

The method results in the production of binding pitch at lower temperatures with high content of α-fraction and reduced volatility

### BRIEF DESCRIPTION OF THE DRAWINGS

FIG. 1 is a schematic diagram of a system for carrying out the method of the invention.

### DESCRIPTION OF THE EMBODIMENTS

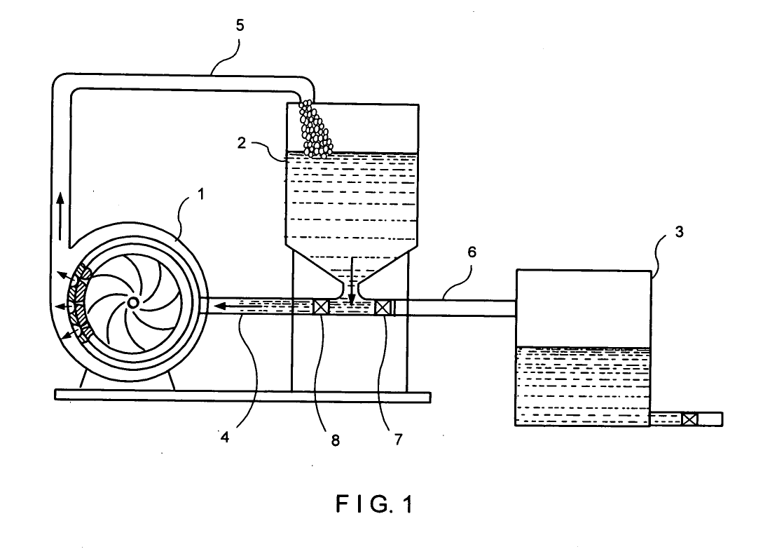

Referring now to FIG. 1 illustrating a schematic diagram of the system adapted to carry out the method of the invention. In the production of the binding pitch the required quantity of the liquefied or molten coal tar pitch is provided. In addition to coal tar pitch, pitch distillates and/or coal tar fractions may be added so as to form an initial coal tar pitch-based component. This component is directed to an aerating device 1 for enrichment by air. Then, by the conduit 5 the air-enriched component is supplied to a production chamber of an emulsifier or hydropercussion and cavitation apparatus 2.

The initial component is directed to an aerating device 1 for enrichment by air or oxygen wherein gas-in-liquid dispersion process is taking place. As illustrated in FIG. 1 the aerating device 1 can include one or more revolving impellers adapted to move and to cause turbulence within the melted or liquefied coal tar pitch-based component. In this manner gas-in-liquid dispersing process throughout the medium of the liquefied component is facilitated. One of the main reasons for such air or oxygen enriching step is to intensify oxidation process of the coal tar pitch-based component in the production chamber of the apparatus 2.

The resulted air-enriched coal pitch-based component is then directed by the conduit 5 to a production chamber of the emulsifier or hydropercussion cavitation apparatus 2. Although the method of the invention will be described utilizing the apparatus 2 having at least one production chamber, it should be noted that the apparatus with multiple production chambers is also contemplated. After processing in the apparatus 2, as will be described in full detail hereinbelow, the resulted product is either accumulated in the holding reservoir 3 for further use and distribution or recirculated back to the aerator 1 for further air enrichment and subsequent treatment.

In the method of the invention the characteristics of the coal pitch-based product are modified through the use of hydropercussion and cavitation pulses. When the pressure in the production chamber of the apparatus 2 is decreased until the liquefied component reaches the boiling point, a great number of vapor-filled cavities and bubbles are formed. The pressure of the liquefied component is increased, such as by raising the temperature, resulting in vapor condensation of the cavities and bubbles. The condensation in turn causes the cavities and bubbles to collapse, creating very large pressure impulses and temperatures. Due to this high energy level, cavitation possesses the ability to mix the components and to aid in chemical reactions.

Further, fluid shear is created by differential velocity within the stream of liquid and is generated by the sudden fluid acceleration upon entering the cavitation chamber due to the difference between the velocity at different parts of the production chamber, and by the intense turbulence. During the collapse of cavitation bubbles, very high localized pressures and temperatures are achieved. These high temperatures and pressures stimulate the progress of various chemical reactions.

In view of the hydropercussion and cavitation pulses generated in the production chamber of the apparatus 2, powerful hydrodynamic disturbances emerge in the production chamber in the form of strong compression-decompression pulses and hydroshock waves. The hydro-cavitation pulses cause chemical changes to the pitch and quickens the overall process. This is done at lower temperatures and at a faster rate than previously known in the art.

Furthermore, the collapse of the cavitation bubbles is accompanied by emission of gases including the air contained oxygen. As a result, the coal pitch which is present in the cavitation zone or in the plume of bubbles of the apparatus is subjected to intensified mixing with pitch distillates and coal tar fractions. The hydropercussion and cavitation pulses substantially facilitate the process of introducing the coal pitch distillates and/or coal tar fractions into the coal pitch structure. This further intensifies the process of producing the pitch binder.

The bubbles developed as a result of hydropecassion and cavitation pulses vastly increase the surface area of the pitch-based component and allow for an intensive gas-in-air dispersion and/or diffusion exchange between the liquid and gas phases. In turn, this process accelerates the chemical reactions. For example, under the action of monatomic oxygen, the highly volatile carbohydrates are broken down. The activity of the monatomic oxygen and the highly reactive surface considerably decreases the time during which the air or atmospheric oxygen must interact with the coal pitch or its mixtures.

The high shearing velocity generates the field of hydropercussion and cavitation pulses which stimulate pitch oxidation processes and its emulsification with coal tar and pitch distillate fractions. The process of pitch oxidation by air oxygen is accelerated in view of the formation of active hydrocarbon radicals in the cavitation domains. The hydropercussion and cavitation pulses ensure efficient participation of air oxygen in the oxidation reaction.

According to the method of the invention, coal tar pitch, which is optionally mixed with coal tar fractions or pitch distillates, passes through the step of air or oxygen enrichment and then is subjected to treatment by hydrodynamic-cavitation pulses at a temperature no greater than 240° C. for the time period shorter than one hour. The frequency of hydrodynamic-cavitation pulses does not exceed 4500 pulses per second. These factors result in the optimum production capacity and pitch performance. The resulting pitch has the following characteristics: softening temperature not less than 85° C.; mass part of the α-fraction not less than 37%; volatilization not more than 53%.

As illustrated in FIG. 1, upon completion of the treatment in the apparatus 2, the resultant binding pitch product can be directed either to the storage tank 3 or recycled back to the aerator 1 for further processing. In such instances, after the aerator 1 the newly air-enriched product is directed by means of the conduit 5 to the apparatus 2 for another round of treatment in the field of hydropercussion and cavitation pulses. In the embodiment where the apparatus 2 having multiple or multi-stage cavitation chambers is used, recycled pitch may be directed to one or more of such chambers. As the length of the period of recirculation and the number of recirculation cycles increase, the resulting binding pitch product generally has a higher degree of purity and further improved other required characteristics. In order to direct the final binding pitch product from the apparatus 2 to the accumulating tank 3, an exit valve 7 associated with the conduit 6 is opened. The valve 8, associated with the conduit 4 and the aerator 1, is typically closed at this time. The finally prepared pitch binder product can be transferred into the holding tank 3 by means of a pump, gravitation forces or any other conventional means. When reprocessing or recirculation of the pitch binder product is required, the exit valve 7 is closed and the valve 8 is open, so as to divert the binding pitch product through the conduit 4 from the apparatus 2 to the aerator 1.

The above method allows for modifications to the supply of liquid, gaseous and other agents. Therefore, the properties of the produced binding pitch may be modified over a broader range than previously realized in the art.

### EXAMPLE

The method of producing binding pitch for electrode materials of the invention has been tested in the experiment, wherein coal tar pitch with a softening temperature of 92° C. was utilized. The pitch was treated in a centrifugal hydrodynamic-cavitation apparatus and was exposed to an air medium at the temperature between 190 and 210° C. Table 1, presented hereinbelow reflects characteristics of the resulted pitch relative to the duration of treatment in the hydrodynamic-cavitation apparatus.

TABLE 1

| | | | Content of | |
|---|---|---|---|---|
| Treatment | Softening | Coking | Volatiles | Toluene insoluble |
| time | temperature | value | (α₁-fraction) | (α-fraction) |
| min | ° C. | % | % | % |
| 0 | 92 | 56.0 | 56.2 | 30.8 |
| 10 | 96 | 58.1 | 54.7 | 33.5 |
| 30 | 101 | 59.2 | 53.2 | 37.0 |
| 50 | 104 | 60.1 | 51.4 | 37.3 |
| 60 | 107 | 61.0 | 51.1 | 37.7 |
| 70 | 107 | 61.1 | 51 | 37.8 |

The method of producing binding pitch of the invention increases production capacity of the process, reduces gas consumption, decreases metal intensity and results in the production of binding pitch at lower temperatures.

1. A method of producing binding pitch for electrode materials, said method comprising the steps of:
enriching a liquefied coal pitch-based component with air; and
exposing said enriched coal pitch-based component to a field of hydropercussion and cavitation pulses.

2. The method of claim 1, wherein said coal pitch-based component is coal pitch.

3. The method of claim 1, wherein said coal pitch-based component is a mixture of said coal pitch and coal tar fractions.

4. The method of claim 1, wherein said coal pitch-based component is a mixture of coal pitch with pitch distillates.

5. The method of claim 1, further comprising the step of heating said coal pitch-based components.

6. The method of claim 5, wherein in said step of heating said coal pitch-based component is heated to a temperature not exceeding 240° C. for a time period not exceeding one hour.

7. The method of claim 1, wherein in said step of exposing said enriched coal pitch-based component is exposed to said hydrodynamic and cavitation pulses having frequency not exceeding 4500 pulses per second.

8. The method of claim 7, wherein said hydrodynamic and cavitation pulses are provided to accelerate process of oxidation of said coal pitch-based component by said air.

9. The method of claim 1, wherein said air contains atmospheric oxygen, so that said hydrodynamic and cavitation pulses are provided to accelerate process of oxidation of said coal pitch-based component by said atmospheric oxygen.
